(19) United States
(12) Patent Application Publication
(10) Pub. No.: US 2023/0017068 A1
(43) Pub. Date: Jan. 19, 2023

(54) High flux anaerobic membrane bioreactor

(71) Applicant: The Board of Trustees of the Leland Stanford Junior University, Stanford, CA (US)

(72) Inventors: Chungheon Shin, San Jose, CA (US); Sebastien Tilmans, San Francisco, CA (US); Craig S. Criddle, San Luis Obispo, CA (US)

(21) Appl. No.: 17/862,703

(22) Filed: Jul. 12, 2022

Related U.S. Application Data
(60) Provisional application No. 63/221,066, filed on Jul. 13, 2021.

(51) Int. Cl. C02F 3/28; C02F 3/00; B01D 69/02; B01D 65/02

(52) U.S. Cl. CPC C02F 3/2853; C02F 3/005; C02F 3/2806; B01D 69/02; B01D 65/02; C02F 2303/16; B01D 2325/02; B01D 2321/18

(57) ABSTRACT

A method for treatment of wastewater includes passing influent wastewater through an anaerobic, anoxic, or bioelectrochemical bioreactor to produce an effluent. The membrane bioreactor includes a membrane with pores having a nominal pore size less than the smallest measured biopolymers and organic nanoparticles in the influent wastewater, thereby preventing them from entering and blocking membrane pores, and further comprising degrading dissolved organics smaller than 20 nm in the influent wastewater within the membrane bioreactor before entering membrane pores.

### CROSS-REFERENCE TO RELATED APPLICATIONS

This application claims priority from U.S. Provisional Patent Application 63/221,066 filed Jul. 13, 2021, which is incorporated herein by reference.

### STATEMENT OF FEDERALLY SPONSORED RESEARCH

None.

### FIELD OF THE INVENTION

The present invention relates generally to methods and systems for wastewater treatment. More specifically, it relates to secondary wastewater treatment using membrane bioreactors.

### BACKGROUND OF THE INVENTION

For over 100 years, domestic wastewater treatment has relied upon aerobic secondary treatment processes that has required energy-intensive aeration to deliver oxygen to aerobic heterotrophic bacteria. A major innovation was the invention of aerobic membrane bioreactors (AeMBR) in the 1960s. As shown schematically in FIG. 1, domestic wastewater 100 enters a primary clarifier 102 whose output enters the AeMBR 104 for secondary treatment. The AeMBR 104 contains membranes that perform separation based on membrane filtration. The membrane permeate effluent 106 is output from the AeMBR 104, and biosolids waste 108 is also produced. Because aerobic heterotrophic bacteria have a high microbial growth yield, aerobic secondary treatment processes have high biosolids production rates. The AeMBR includes a blower 110 for aeration and its high energy usage requires 1˜2% of US electricity consumption, and high biosolid production rates constitute ˜13% of the overall operational expenditure for domestic wastewater treatment plants operation.

In the 2010s, anaerobic membrane bioreactors (AnMBRs) that can improve the energy efficiency of domestic wastewater treatment and produce less biosolids were investigated for a possible replacement of aerobic secondary treatment technology. As shown schematically in FIG. 2, wastewater 200 flows through an optional primary clarifier 202 whose output flows into an AnMBR 204 for secondary treatment. The AnMBR 204 contains membranes 205 that perform separation based on membrane filtration. The membrane permeate effluent 206 is output from the AnMBR 204, and biosolids waste 208 is also produced. The AnMBR 204, also includes a blower 212. AnMBRs make use of anaerobic microorganisms, which convert organic matter present in the wastewater to biogas methane 210 instead of requiring energy-intensive aeration. The anaerobic microorganisms have a small growth yield, resulting in more than 70% reduction in biosolids production compared to AeMBR systems.

However, conventional AnMBRs have a critical limitation, impeding their commercialization at full-scale. The critical limitation of conventional AnMBRs is rapid membrane fouling. High membrane fouling rates limit the maximum net flux to less than ˜14 L/m²/h, which is substantially lower than aerobic membrane bioreactors with values >25 L/m²/h. The low flux of AnMBRs limits water productivity (L/h) per membrane surface area (m²), increasing capital costs and reactor footprint. Furthermore, low flux limits the energy benefits of AnMBRs relative to conventional aerobic processes because substantial energy is required to control membrane fouling. These limitations decrease the competitiveness of this promising technology.

### SUMMARY OF THE INVENTION

The inventors have discovered that domestic wastewater can have 10-30% of its organic constituent in the size range that poses challenges for AnMBRs operation with typical ultrafiltration membranes. As a result, membranes with conventional pore sizes increase retention of the ultrafine particles and their degradation to methane within an AnMBR system. The inventors discovered that the underlying cause of low flux in conventional AnMBRs is the presence of ultrafine colloidal organics (0.02-0.03 μm) in wastewater, which can contribute to irreversible membrane fouling by blocking internal membrane pores. It also contributes to lower quality effluent. At present, the industry is unaware of this issue, and there is limited availability of membranes with very small pore size. This is because aerobic membrane bioreactors dominate the market at present and are not subject to this problem. The ultrafine colloidal organic particles do not present a problem for aerobic systems that have natural bio-flocculation of the colloids and fast hydrolysis, effectively eliminating the ultrafine particles before they can foul the membranes. It was unexpected that these ultrafine colloidal organics would be present and cause fouling problems in AnMBRs. Counterintuitively, this discovery means that ultrafiltration membranes with smaller pore size (no larger than 0.02 μm) can enable higher flux operation with lower energy losses in AnMBRs and also can enable more energy production as methane. An anaerobic membrane bioreactor with a small mean membrane entrance pore size of at most 0.02 μm will prevent colloids from entering and fouling membranes, enabling (1) higher quality of secondary effluent, (2) more energy production due to more methane production, (3) higher flux operation with decreased energy losses and less frequent chemically-intensive cleanings, (4) lower capital cost for membranes, and (5) smaller footprint.

In one aspect, a method for treatment of wastewater is provided, the method comprising passing influent wastewater, such as municipal wastewater, through a membrane bioreactor to produce an effluent, where the membrane bioreactor is an anaerobic, anoxic, or bioelectrochemical bioreactor, where the membrane bioreactor comprises a membrane with pores having a nominal pore size is less than the smallest measured biopolymers and organic nanoparticles in the influent wastewater, thereby preventing them from entering and blocking membrane pores, and further comprising degrading dissolved organics smaller than 20 nm in the influent wastewater within the membrane bioreactor before entering membrane pores.

Preferably, the nominal pore size of the membrane is 20 nm or less. Preferably, the bioreactor does not contain flocculant microbial biomass. Preferably, biopolymers and/or organic nanoparticles with hydrolytic enzymes are concentrated in the membrane bioreactor retentate, enabling more efficient and rapid hydrolysis. In one embodiment, the bioreactor is anaerobic and produces methane. In an alternate embodiment, the bioreactor is anoxic and produces molecular nitrogen (N₂). In another embodiment, the bioreactor is a bioelectrochemical system incorporating exoelectrogens. In some embodiments, the bioreactor contains biofilms. In some embodiments, the bioreactor is operated to undergo alternating periods of membrane relaxation and surface turbulence (e.g., gas sparging) such that foulants are removed from the membrane surface. Preferably, the effluent from the membrane bioreactor is operated to have a net flux greater than 6 L/m²/h.

### BRIEF DESCRIPTION OF THE DRAWINGS

FIG. 1 is a schematic diagram illustrating a conventional aerobic membrane bioreactor (AeMBR) used for secondary treatment of wastewater.

FIG. 2 is a schematic diagram illustrating a conventional anaerobic membrane bioreactor (AnMBR) used for secondary treatment of wastewater.

FIG. 3 is a schematic diagram illustrating a microbial bioreactor used in a method for treatment of wastewater according to embodiment of the present invention.

FIGS. 4A-B show isometric and longitudinal cross-sectional views of a hollow fiber membrane used in a bioreactor according to embodiments of the present invention.

FIG. 5A is a cross-sectional view of a portion of a conventional ultrafiltration membrane, illustrating ultrafine COD (UFCOD) foulant particles attached to the interior portions of the pores, causing irreversible fouling of the membrane.

FIG. 5B is a cross-sectional view of a portion of an ultrafine membrane according to an embodiment of the present invention, illustrating prevention of irreversible fouling by blocking ultrafine COD (UFCOD) foulants from entering the membrane pores.

FIG. 6A is a schematic diagram of a microbial bioreactor incorporating a moving media for biofilm formation, according to an embodiment of the invention.

FIG. 6B is a schematic diagram of a microbial bioreactor incorporating a fixed electrode for biofilm formation with exoelectrogens, according to an embodiment of the invention.

FIG. 7 is a graph summarizing the size range of ultrafine colloidal organic matter (15-30 nm) in domestic wastewater.

FIG. 8 is a graph summarizing different permeate COD (mg/L) depending upon membrane pore size (nm) for a pilot-scale AnMBR treating domestic wastewater.

FIG. 9 is a graph that compares decreasing ratios of permeability for 40 nm and 10 nm membrane pores when filtering the same AnMBR concentrate.

FIG. 10 is a graph summarizing membrane flux (L/m²/h) conditions depending upon membrane pore size (nm).

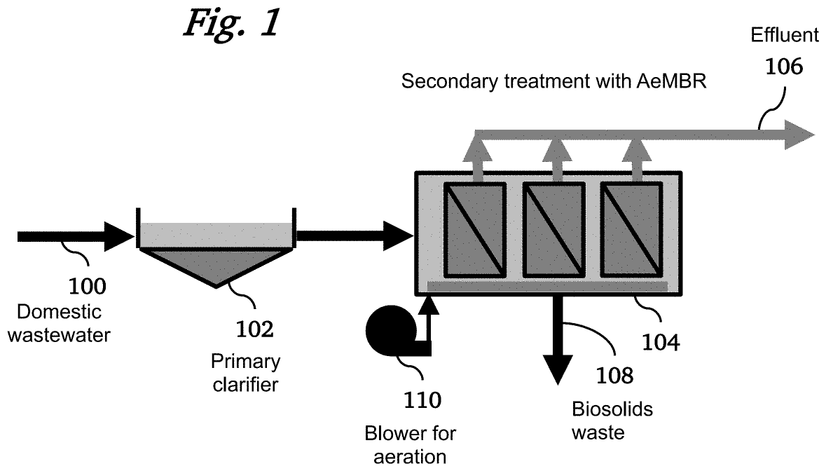

### DETAILED DESCRIPTION OF THE INVENTION

Herein we disclose, in one embodiment of the invention, a high-flux AnMBR that that makes use of small pore size membranes (at most 0.02 μm) to enable high-flux operation, high quality effluent, and increased energy production as biogas methane. Unlike previous methods that used membranes with pore sizes of 40 nm or more, the present methods use an anaerobic microbial bioreactor incorporating membranes with a nominal pore size less than 20 nm. This was not obvious before because it was not realized that anaerobic bioreactors cannot remove organic nanoparticles (16˜40 nm) and thus, while previous approaches were able to address membrane cake layer fouling (on the surface of membranes), they were not able to address pore blocking. The inventors have demonstrated that a finer pore size membrane can reduce membrane irreversible fouling because ultrafine colloidal substrates (0.02˜0.03 μm) are rejected at the membrane surface, forming a cake that is readily controllable by conventional fouling control methods.

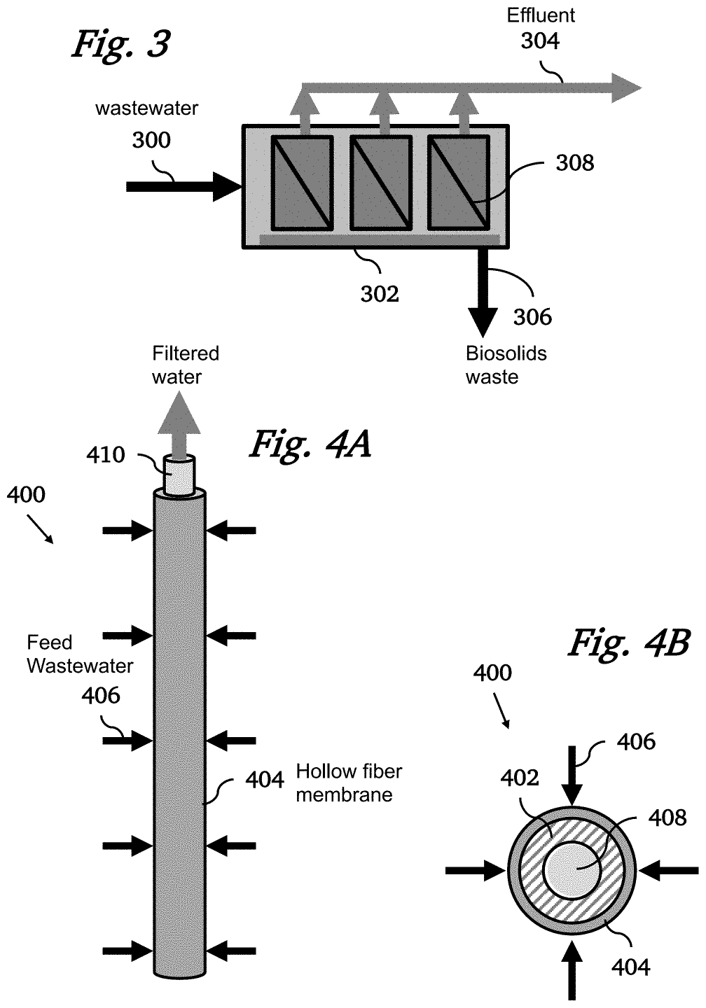

In one embodiment of the invention, a method for treatment of wastewater is implemented using microbial bioreactor, as shown in FIG. 3. Influent wastewater 300 is passed through the microbial bioreactor 302 to produce effluent 304 and biosolids waste 306. Influent wastewater 300 may be, for example, domestic or municipal wastewater. The microbial bioreactor 302 contains non-flocculant biomass (i.e., anaerobic or anoxic microorganisms, or exoelectrogens) and preferably does not contain any flocculant organisms. The microbial bioreactor 302 includes at least one membrane 308 with pores having a nominal pore size at a surface of the membrane less than a predetermined value selected to be the smallest measured particle diameter of biopolymers and organic nanoparticles contained in the influent wastewater 300 which the bioreactor was designed to treat. As a result, the biopolymers and organic nanoparticles are prevented from entering the pores of the membranes, thereby mitigating pore blockage while enhancing permeate quality. Preferably, the nominal pore size of membrane is less than 20 nm, or more preferably less than 15 nm. Such membranes may be obtained, for example, from Toray Membrane USA, Inc. More generally, the size of pores at the membrane surface are sufficiently small to prevent blockage of the internal portions of the pores. Surprisingly, despite the reduced pore size compared to conventional anaerobic microbial bioreactors, the reactor disclosed here can provide a net flux greater than 6 L/m²/h.

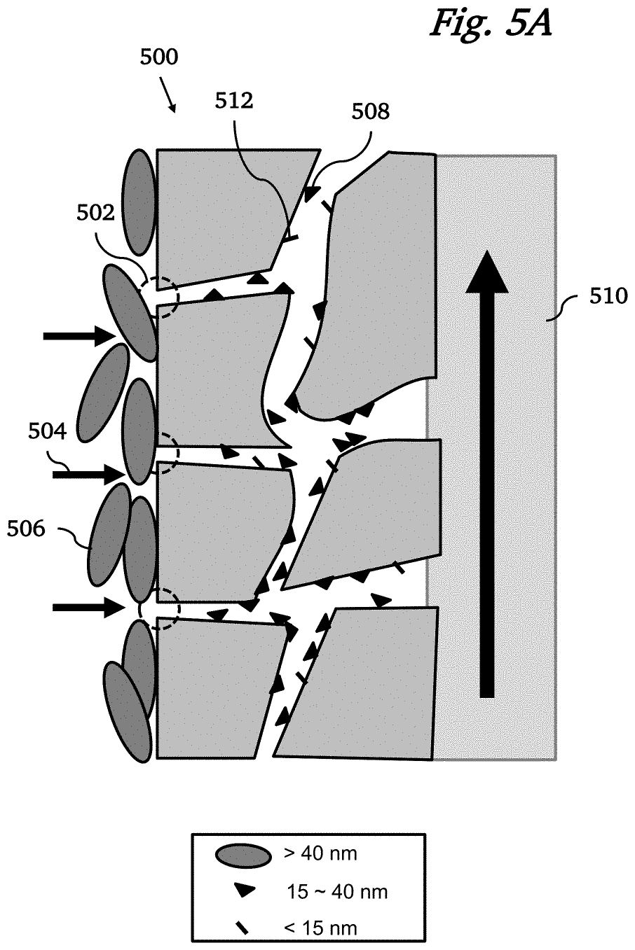

An example of a hollow fiber membrane 400 is shown in FIGS. 4A-B. A hollow cylindrical support layer 402 that allows effluent to freely pass through it provides structural support for a surrounding cylindrical layer of membrane polymer 404 (e.g., polyvinylidene difluoride). The wastewater 406 flows radially from outside, through the membrane layer 404 and support layer 402, and into a central channel 408 inside the hollow cylindrical support layer 402. Once in the central channel, the effluent 410 flows longitudinally and exits the filter through one end.

Conventional AnMBR membranes have a nominal pore size of 100 to 200 nm for microfiltration (MF) and 30 to 40 nm for ultrafiltration (UF). Organic nanoparticles smaller than this nominal membrane pore size may not be retained. Accordingly, we define COD that can pass through ultrafiltration membranes as ultrafine COD (UFCOD). UFCOD nanoparticles ranging in size from 16-30 nm typically have a peak size close to 20 nm, smaller than the nominal pore size of conventional UF membranes (40 nm). The 20 nm peak is close to the size range of humic polymer colloids, organic nanoparticles, and phage.

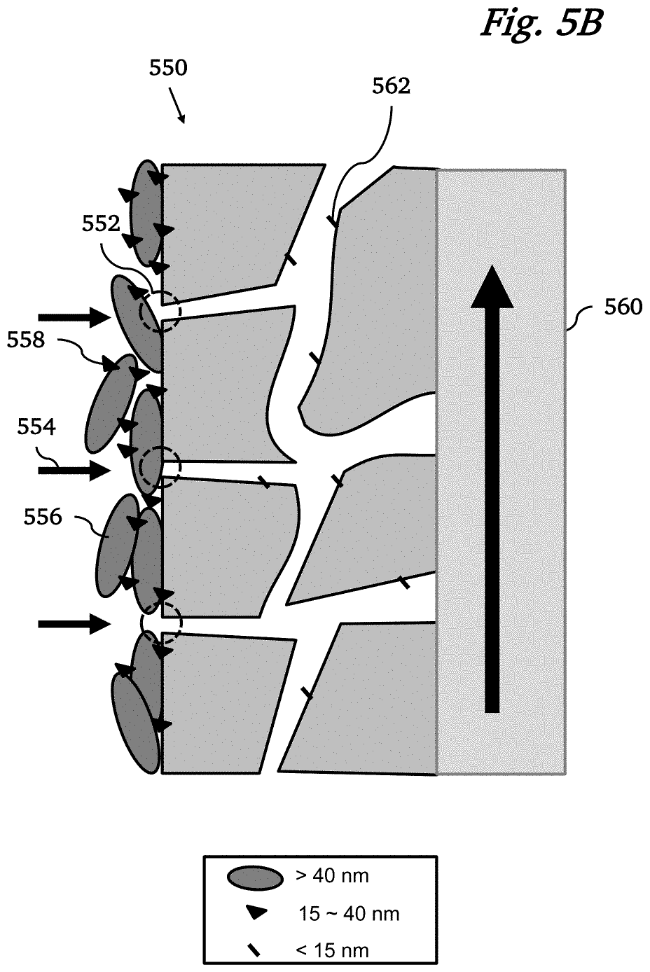

FIG. 5A shows a close up of a conventional ultrafiltration membrane 500 having pores 502 with nominal size at the membrane surface of 40 nm or more. Wastewater 504 flows through the membrane from left to right. As the wastewater 504 is filtered to produce filtered effluent 510, foulant particles 506 with size greater than the membrane pore size at the surface are caked at the membrane surface. This fouling at the surface is reversible. However, as the present inventors have discovered, UFCOD foulant particles 508 and 512 with size less than the membrane pore size at the surface can enter the pores and become attached to the interior portions of the pores, blocking the pores and causing irreversible fouling of the membrane.

FIG. 5B shows a close up of a membrane 550 according to the present invention having pores 552 with nominal size at the membrane surface of 20 nm or less. Wastewater 554 flows through the membrane from left to right. As the wastewater 554 is filtered to produce filtered effluent 560, foulant particles 556 and 558 with size greater than the membrane pore size at the surface are caked at the membrane surface. In contrast to the membrane of FIG. 5A, this membrane prevents smaller ultrafine COD foulant particles 558 from entering the pores and causing irreversible fouling. The UFCOD particles form cake layer fouling that is controllable with gas sparging of the membranes with recycled biogas blown at the base of the membranes. Although some UFCOD particles 562 with size less than the membrane pore size can enter the pores and become attached to the interior portions of the pores, these are far fewer and smaller, and do not substantially block the flow through the pores.

In some embodiments, the membranes with a nominal pore size less than 20 nm 308 reject and concentrate biopolymers and/or organic nanoparticles with hydrolytic enzymes in the retentate, enabling more efficient and rapid hydrolysis of biopolymers and/or organic nanoparticles.

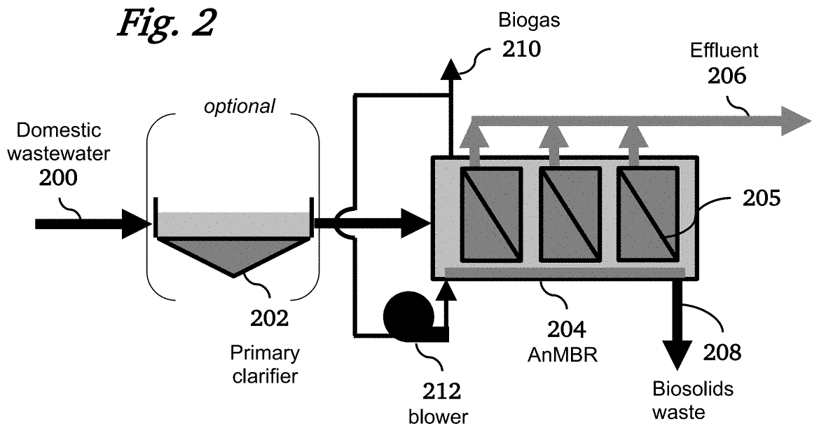

In a preferred embodiment of the invention, the bioreactor 302 is anaerobic and produces methane. In such an embodiment the reactor includes a methane exhaust, as shown in FIG. 2. In another embodiment, the bioreactor 302 is anoxic and produces molecular nitrogen (N₂).

In embodiments of the invention where the bioreactor 302 is an anaerobic microbial bioreactor, a membrane fouling control strategy is preferably performed, e.g., alternating periods of membrane relaxation and membrane surface turbulence (e.g., gas sparging) to detach foulants.

In an alternate embodiment, the bioreactor 302 is anoxic. In such embodiment, the bioreactor produces molecular nitrogen (N₂).

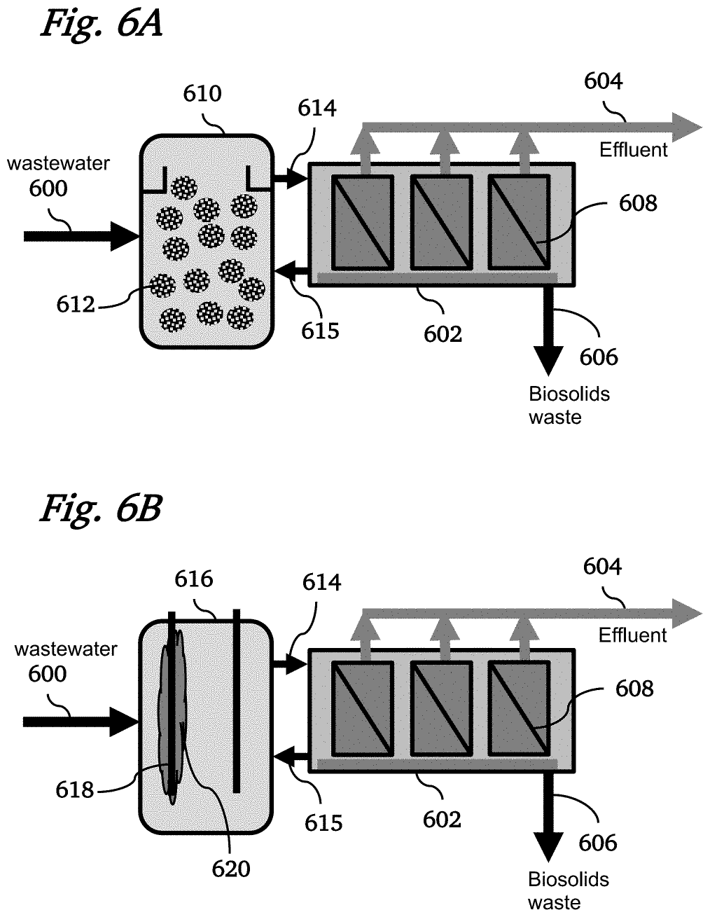

In some embodiments, the bioreactor comprises biofilms. For example, a method for treatment of wastewater is implemented using microbial bioreactor incorporating a moving media for biofilm formation, as shown in FIG. 6A. Influent wastewater 600 is passed through the microbial bioreactor 610, 602 to produce effluent 604 and biosolids waste 606. Influent wastewater 600 may be, for example, domestic or municipal wastewater. The microbial bioreactor first stage 610 contains moving media 612 covered with microbial biomass. The wastewater recirculates between first stage 610 and second stage 602 through external recirculation lines 614, 615. The microbial bioreactor second stage 602 is a membrane tank that includes at least one membrane 608 with pores having a nominal pore size at a surface of the membrane less than the smallest measured particle diameter of biopolymers and organic nanoparticles contained in the influent wastewater 600.

In another example, a method for treatment of wastewater is implemented using microbial bioreactor incorporating a fixed electrode for biofilm formation with exoelectrogens, as shown in FIG. 6B. Influent wastewater 600 is passed through the microbial bioreactor 616, 602 to produce effluent 604 and biosolids waste 606. Influent wastewater 600 may be, for example, domestic or municipal wastewater. The microbial bioreactor first stage 616 is an electrochemical bioreactor that contains a fixed electrode 618 covered with exoelectrogens 620. The wastewater recirculates between first stage 616 and second stage 602 through external recirculation lines 614, 615. The microbial bioreactor second stage 602 is a membrane tank that includes at least one membrane 608 with pores having a nominal pore size at a surface of the membrane less than the smallest measured particle diameter of biopolymers and organic nanoparticles contained in the influent wastewater 600.

We now present experimental data demonstrating innovative features of the present invention.

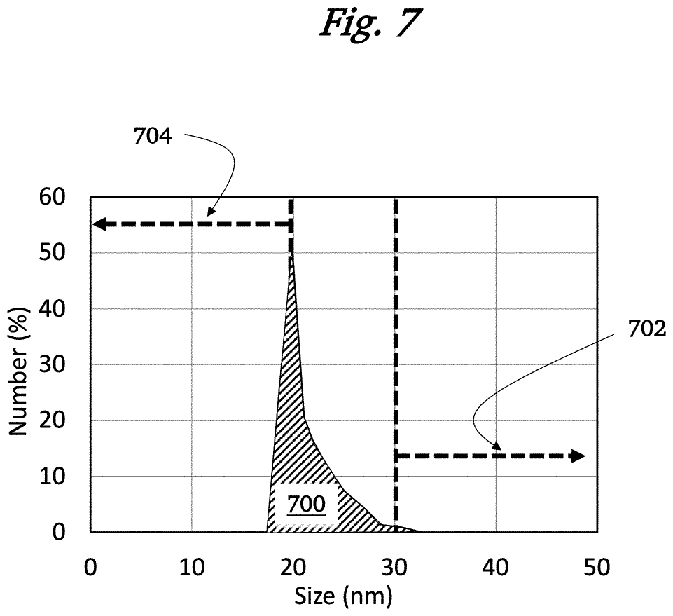

FIG. 7 is a graph summarizing the size range of ultrafine colloidal organic matter (15-30 nm) in domestic wastewater 700, which is smaller than the nominal pore size range of membranes in conventional membrane bioreactors (MBRs) 702. The concentration of ultrafine colloidal organic matter (S_{UF}) is governed by hydraulic retention time (HRT) and first-order kinetics for hydrolysis (k_{hyd}^{UF})

$$\frac{{dS}_{UF}}{dt} = \frac{{S}_{UF}^{0}}{HRT} - \frac{{S}_{UF}}{HRT} - {k}_{hyd}^{UF} {S}_{UF}$$

In conventional aerobic MBRs, k_{hud}^{UF} is faster than the rate at which water passes through the membrane (1/HRT): k_{hyd}^{UF}>>1/HRT. This is because aerobic systems bio-flocculate with colloids and have high rate of hydrolysis, enabling rapid biological consumption of S_{UF}, high-quality permeate and low membrane pore blockage due to low S_{UF}.

Anaerobic MBRs (AnMBRs) lack bio-flocculation, and, as a result, the rate of hydrolysis is much slower (k_{hyd}^{UF}, 1.9 1/d) than the rate at which water passes through the membrane (1/HRT, 4.8 1/d), resulting in ineffective biological degradation of S_{UF}, higher permeate COD, and more membrane pore blockage due to high S_{UF}.

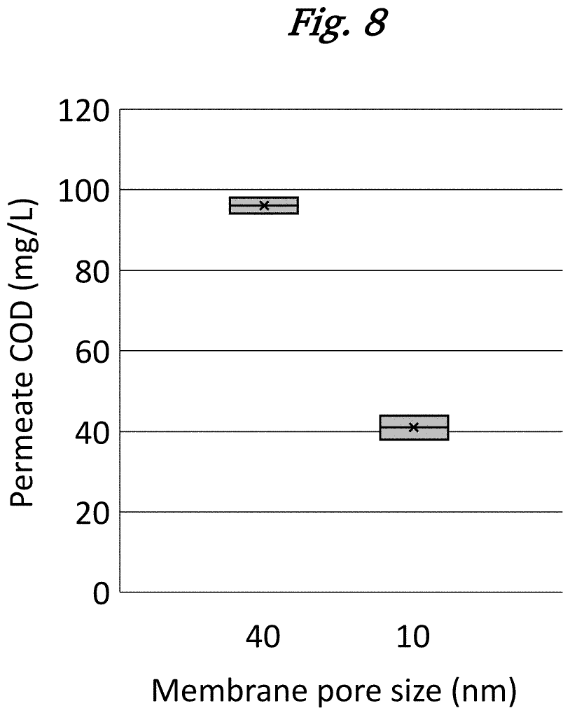

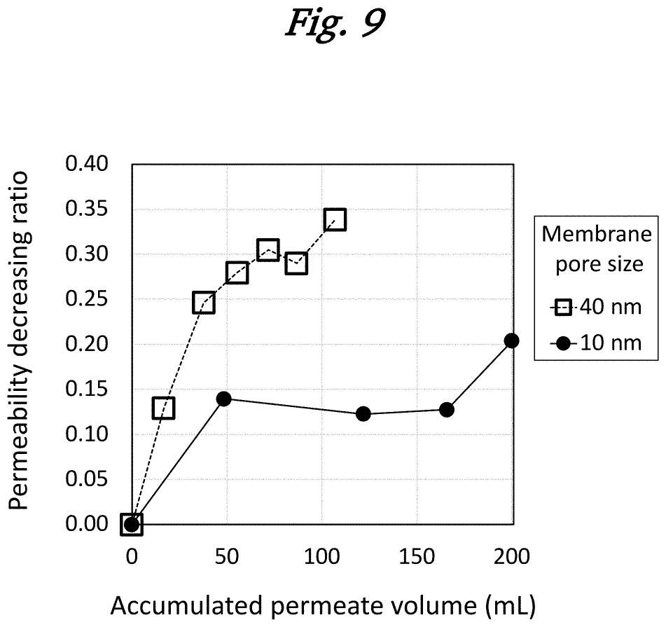

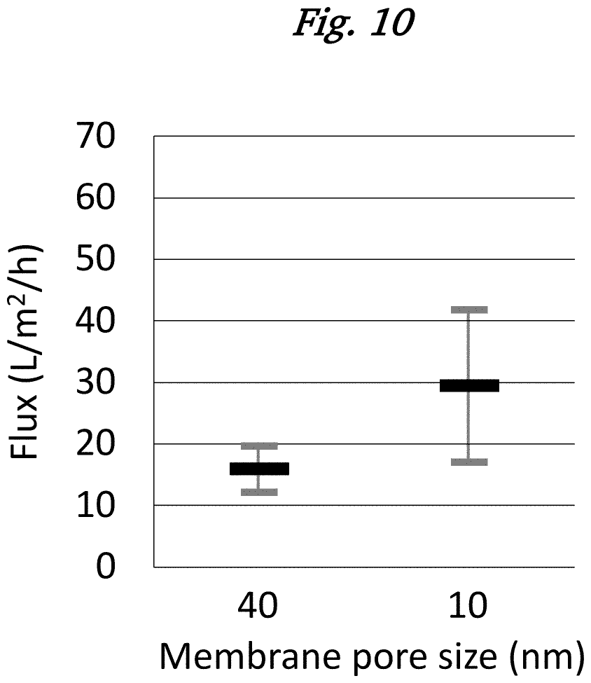

Counterintuitively, ultrafiltration membranes with smaller pores (nominal pore size less than 20 nm, preferably smaller than 15 nm) prevent passage of ultrafine colloidal organic matter through the membranes 704. By doing so, the hydrolysis of ultrafine colloidal organic matter is governed by solids retention time SRT (>20 days), which is much longer than HRT (˜5 hours), enabling low S_{UF} within the system and permeate (FIG. 8), with less membrane pore blockage (FIG. 9) and higher-flux (FIG. 10).

FIG. 8 is a graph summarizing different permeate COD (mg/L) depending upon membrane pore size (nm) for a pilot-scale AnMBR treating domestic wastewater. As shown in FIG. 8, permeate that passes through 40 nm membranes in an AnMBR treating domestic wastewater had higher COD (96 mg/L) than permeate that passes through 10 nm membranes in the same system (41 mg/L). Lower COD in the permeate translates to higher quality effluent and more methane production.

FIG. 9 is a graph that compares decreasing ratios of permeability for 40 nm and 10 nm membrane pores when filtering the same AnMBR concentrate: permeability decreased by 30-35% in 40 nm membranes, and by 20% in 10 nm membranes.

FIG. 10 is a graph summarizing membrane flux (L/m²/h) conditions depending upon membrane pore size (nm). Under the same operating conditions (i.e., same wastewater, same temperature, and same TMP of ˜0.4 bar), the 10 nm membrane enabled higher flux operation (˜30 L/m²/h) than the 40 nm membrane (˜16 L/m²/h).

High flux reactors according to the present invention could be employed for municipal wastewater treatment but also in numerous other industrial wastewater applications, e.g., food and beverage, textiles, and agricultural applications.

1. A method for treatment of wastewater, comprising passing influent wastewater through a membrane bioreactor to produce an effluent, where the membrane bioreactor is an anaerobic, anoxic, or bioelectrochemical bioreactor, where the membrane bioreactor comprises a membrane with pores having a nominal pore size is less than the smallest measured biopolymers and organic nanoparticles in the influent wastewater, thereby preventing them from entering and blocking membrane pores, and further comprising degrading dissolved organics smaller than 20 nm in the influent wastewater within the membrane bioreactor before entering membrane pores.

2. The method of claim 1 wherein the nominal pore size of the membrane is 20 nm or less.

3. The method of claim 1 wherein biopolymers and/or organic nanoparticles with hydrolytic enzymes are concentrated in the membrane bioreactor retentate, enabling more efficient and rapid hydrolysis.

4. The method of claim 1 wherein the bioreactor is anaerobic and produces methane.

5. The method of claim 1 wherein the bioreactor is anoxic and produces molecular nitrogen (N₂).

6. The method of claim 1 wherein the bioreactor is a bioelectrochemical system incorporating exoelectrogens.

7. The method of claim 1 wherein the bioreactor contains biofilms.

8. The method of claim 1 wherein the wastewater is municipal wastewater.

9. The method of claim 1 wherein the bioreactor does not contain flocculant microbial biomass.

10. The method of claim 1 further comprising operating the bioreactor to undergo alternating periods of membrane relaxation and surface turbulence (e.g., gas sparging) such that foulants are removed from the membrane surface.

11. The method of claim 1 wherein the effluent from the membrane bioreactor has a net flux greater than 6 L/m²/h.
